(19) United States
(12) Patent Application Publication
(10) Pub. No.: US 2015/0367616 A1
(43) Pub. Date: Dec. 24, 2015

(54) PRESSURE-TRANSFERRED COMPONENTS

(71) Applicant: The Board of Trustees of the Leland Stanford Junior University, Palo Alto, CA (US)

(72) Inventors: Mark G. Christoforo, Stanford, CA (US); Michael D. McGehee, Palo Alto, CA (US); Alberto Salleo, San Francisco, CA (US); Colin D. Bailie, Palo Alto, CA (US)

(21) Appl. No.: 14/739,878

(22) Filed: Jun. 15, 2015

Related U.S. Application Data
(60) Provisional application No. 62/013,846, filed on Jun. 18, 2014.

(51) Int. Cl. B32B 37/00; B32B 37/06

(52) U.S. Cl. CPC B32B 37/025; B32B 37/06

(57) ABSTRACT

In accordance with various embodiments, a front surface of a donor substrate is placed upon a surface of an acceptor substrate, with the front surface having donor material formed thereupon. A portion of the donor material is transferred from the donor substrate to a target surface region of the acceptor substrate, by applying a localized-force to a back surface of the donor substrate that is opposite the donor material in the region being transferred. The force is applied in such a way that, if or when the donor and acceptor substrates are physically separated, a portion of the donor material remains on the acceptor substrate in the region(s) the force was applied.

### FEDERALLY-SPONSORED RESEARCH AND DEVELOPMENT

This invention was made with Government support under contract DE-EE0004946 awarded by the Department of Energy. The Government has certain rights in this invention. The Government has certain rights in this invention.

### OVERVIEW

Various electronic and other devices are susceptible to damage or other undesirable conditions when exposed to certain manufacturing approaches. For instance, certain devices are sensitive to temperature, solvent/chemicals, and pressure. Further, certain components within devices benefit from certain formation techniques such as those involving high temperature, the use of solvent or high pressure, but cannot enjoy the benefits of such aspects due to limitations of other circuitry or components within the device. These issues can result in limited performance or failure. These and other matters have presented challenges to the implementation of materials such as conductive electrodes, for a variety of applications.

In accordance with various embodiments, a front surface of a donor substrate is placed upon a surface of an acceptor substrate, with the front surface having donor material formed thereupon. A portion of the donor material is transferred from the donor substrate to a target surface region of the acceptor substrate, by applying a localized-force to a back surface of the donor substrate that is opposite the donor material in the region being transferred. The force is applied in such a way that, if or when the donor and acceptor substrates are physically separated, a portion of the donor material remains on the acceptor substrate in the region(s) the force was applied. Various embodiments are directed to such an approach for transferring conductive material to form a transparent electrode (an electrode that passes some or most light incident upon the electrode), and that can be implemented under conditions in which the use of high heat, solvent or high pressure can be mitigated.

Another embodiment is directed to an apparatus having characteristics manifested via approaches as described above. The apparatus has a substrate and a conductive material impressed upon a surface of the substrate in a pattern. The conductive material and portions of the substrate laterally adjacent the conductive material have a contiguous shape that conforms to a localized force applied to the substrate and to the conductive material. In various implementations, the shape includes a portion that is indented into the surface of the substrate.

Various example embodiments are directed to apparatuses, systems, methods of use, methods of making, or materials that address these challenges, such as those described in the claims, description or figures herein and in the Appendices A-B that were filed as part of the provisional application and accompany this patent document, all of which are fully incorporated herein by reference.

### DESCRIPTION OF THE FIGURES

Various example embodiments may be more completely understood in consideration of the following detailed description in connection with the accompanying drawings, in which:

FIG. 1 shows an apparatus and approach for transferring material from a donor substrate to an acceptor substrate, in accordance with one or more embodiments; and

FIG. 2 shows an apparatus and exemplary devices in which the apparatus may be employed, in accordance with one or more example embodiments of the present disclosure.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving the transfer of material, such as by transferring conductive material and forming an electrode or other type of conductive structure. While not necessarily so limited, various aspects may be appreciated through a discussion of examples using this context.

Various example embodiments are directed to the formation of electrodes or other material via a transfer process, as well as the structure thereof, as may be implemented in a variety of applications. Various such embodiments are described in Appendices A and B of the underlying provisional application, which form part of this patent document. In some implementations, conductive nanomaterial such as silver, graphene, carbon nanotubes or other conductors are physically transferred from a donor substrate to an acceptor substrate. This approach can be carried out without degrading performance parameters of the electrode or the acceptor substrate, such as by addressing challenges relating to one or more of incomplete transfer, discontinuity, and substrate cracking Further, this approach can be used to form a multitude of devices, such as flexible or rigid organic light-emitting diode (OLED) lights, thin film displays, solar cells and other photovoltaic devices.

In a more particular embodiment, conductive material such as silver nanowires (AgNWs) is deposited onto a donor substrate, using one or more methods (e.g., spraying, spinning, printing, and slot dye coating). The donor substrate may, for example, be a thin, non-rigid substrate such as 3 mil thick PET (plastic) or metal foil. The film may be further processed (e.g., annealed and/or pressed) to set performance characteristics to particular values. This approach may, for example, involve forming a transparent electrode with transparency characteristics set to suit particular embodiments (e.g., to pass the majority of light incident thereupon).

The donor substrate coated with the conductive material is placed face down and directly contacts the acceptor substrate. The acceptor substrate may, for example, be part of a partially built solar cell, flat panel display, OLED or other circuit. One such application involves forming semi-transparent solar cells implemented as window coatings or as a top cell in a multi junction solar cell. In various implementations, the acceptor substrate is solvent sensitive, temperature sensitive or otherwise delicate with regard to materials and device layers, with the transfer process implemented herein being amenable to providing an electrode under such conditions (e.g., using a solvent-free, low-temperature and low-pressure application). For example, if a solution-processed solar cell or a polymer LED (PLED) is exposed to temperatures over 200° C. for an extended period, the structure may melt. Further, solution-processed device layers may degrade upon exposure to solvent, and certain electrodes benefit from annealing that would otherwise harm underlying circuitry in certain applications. For instance, some OLEDs emit light from both the top and bottom of a device stack, which can pose challenges to electrode formation. As such, various embodiments address these issues via formation of an electrode on a donor substrate, with subsequent transfer to an acceptor substrate without necessarily using solvent or high temperatures, and at relatively low pressure.

In some embodiments, a force-spreading sheet is placed on top of the donor substrate (e.g., by placing a 0.19 mm thick glass sheet), and pressure is applied to the donor substrate. In some embodiments, one or more ball bearings (e.g., ¼ inch steel ball bearings) are rolled over the force-spreading sheet and the donor substrate, with light (e.g., 500 g) downward force. The ball bearing can be selectively rolled over any area for selective area patterning, such as to provide an electrode having conductive material in the pattern, or to form an interconnect structure. The ball bearing(s) can also be implemented in a roll-to-roll process, with multiple ball bearings being applied to a sheet. In certain embodiments, the donor substrate is patterned with the conductive material such that complete transfer of the conductive material in the pattern results in the acceptor substrate having the pattern. In other embodiments, the transfer process is carried out such that only certain portions of the conductive material on the donor substrate are transferred, to set a pattern via the transfer process.

In various implementations, the transfer as discussed above is carried out to donate an electrode to the acceptor substrate without damaging the electrode or substrate. In some implementations, the electrical conductivity of the electrode is improved during transfer by forcing overlapping conductors from the donor substrate together at their junctions, as the conductors are pressed onto the acceptor substrate. Such approaches may, for example, be implemented to transfer an electrode to a substrate having circuitry formed therein, permitting fabrication of the electrode separately from that of the circuitry in the substrate.

Once the transfer is complete, the donor substrate and force-spreading layer can be removed. The conductive material remains embedded in the acceptor substrate and can be used to transport current laterally along its surface (and, for transparent applications, while allowing light to pass through). Such an approach may, for example, be used to laminate an electrode having 92% light transmission and 8 ohms/square onto a temperature and solvent sensitive perovskite-based solar cell. The resulting electrode may exhibit performance consistent with a 100 nm thick thermally-evaporated opaque gold electrode.

A more particular embodiment is directed to a hybrid cell having a high-bandgap, defect-tolerant top cell and a commercial bottom cell. Such a larger bandgap as a top layer can be implemented to absorb high-energy photons while being transparent to low-energy photons that are absorbed in an underlying layer (relative to the direction of incident light). A transparent solution-processed silver nanowire electrode is provided on a perovskite solar cell to achieve a 12.7% semi-transparent device. The semi-transparent cell is stacked in a 4-terminal tandem configuration onto a copper indium gallium diselenide (CIGS) material and/or silicon substrates. Operation of the CIGS can be enhanced from 17.0% to 18.6%, and silicon can be enhanced from 11.4% to 17.0%, when implementing a tandem cell. Using such approaches, perovskites can be implemented in low cost and high efficiency (e.g., >25%) multi junction cells.

In some embodiments, after material has been transferred as discussed herein, additional material is thermally evaporated (e.g., through a patterned shadow mask) around edges. This approach may be implemented, for example, to add bars of silver to reduce the series resistance in a AgNW electrode transferred to an acceptor substrate, by facilitating current collection in more than one geometrical direction.

Material is deposited on a donor substrate using one or more of a variety of approaches. In some embodiments, a spray deposition method is used in a manner that ensures a transmission/conductivity tradeoff to maximize power conversion efficiency of a tandem perovskite solar cell. For instance, a spray nozzle can be positioned about 76 mm above a donor substrate for spraying 4.5 mg of AgNWs (e.g., 35 nm in diameter and 15 μm in length) upon on 5 mil thick polyethylene terephthalate (PET) donor substrate. PET can facilitate transfer via decoupling with the AgNW film upon impression of the film into an acceptor substrate.

A bearing is used to apply pressure to the PET, with a rolling action that reduces lateral shear force and prevents movement of the PET substrate relative to the acceptor perovskite solar cell. This approach can mitigate issues with lateral movement, which may otherwise cause discontinuities in the resulting laminated film and degrade conductivity. The flexibility and softness of the PET substrate is used to conform the AgNW film to the surface of the perovskite device during transfer, and can achieve the conformity despite dust or other imperfections that may be present on one or more of the surfaces of the film, PET substrate or other component used in the transfer. This, coupled with the relatively small contact point of the ball bearing facilitates complete transfer lamination of the AgNW film to the perovskite device without damaging the AgNW film in the presence of dust or other imperfections.

A transfer force is chosen to be sufficient to ensure that the AgNWs are completely donated from the PET, but not so high such that components are damaged. For instance, where a spiro-OMeTAD (2,2′,7,7′-tetrakis(N,N′-di-p-methoxyphenylamine)-9,9′-spirobifluorene) layer is deposited onto a perovskite solar cell, the transfer force may be maintained low enough to mitigate any forcing of AgNWs though the spiro-OMeTAD layer and causing bridges across it (such AgNW bridges may lead to increased recombination, as the spiro-OMeTAD layer can no longer effectively block electrons and may be shunted if the nanowires also push through other layers).

In certain embodiments, a coverslip is placed over the PET substrate to facilitate transfer. For instance, such a coverslip may be implemented to isolate lateral movement of the ball bearing from the PET, which prevents cracks, or discontinuities in the transferred AgNW film as described above. Such a coverslip may also be implemented to increase an area over which the force from the ball bearing is applied to the PET, thus reducing the pressure felt by the AgNWs during the transfer process (while maintaining a higher pressure at locations to which the ball bearing is applied). This reduced pressure may, for instance, provide a further safeguard against AgNWs bridging through the spiro-OMeTAD layer.

In accordance with another embodiment, an apparatus is manufactured as follows. A front surface of a donor substrate is placed upon a surface of an acceptor substrate. The front surface has a material formed thereupon, such as a conductive material, prior to the donor substrate being placed upon the surface. For instance, a conductive material may be deposited on a front surface of the donor substrate, and which is configured with the donor substrate to release the conductive material in response to a localized force and to transfer about all of the conductive material to the acceptor substrate via the localized force.

A localized force is applied to the donor substrate (e.g., via a roller or ball bearing), and a portion of the material is transferred from the donor substrate to a target surface region of the acceptor substrate. Specifically, the localized force is applied to a back surface of the donor substrate that is opposite the front surface, either directly or via an intervening component (e.g., a coverslip or other force-spreading material), while using the donor substrate and/or such an intervening component to mitigate application of the applied localized force to other surface regions of the acceptor substrate that are adjacent the target surface region. In some implementations, an applied force can be concentrated upon regions of the acceptor substrate to which the material is to be transferred. Accordingly, the donor material is transferred in such a way that, if the donor and acceptor substrates were physically separated, a portion of the donor material would remain on the acceptor substrate in the region(s) the force was applied. In some implementations, the donor material includes conductive particles that are transferred for forming an electrode on the acceptor substrate; the conductive particles form an electrically conductive surface and pass a majority of incident light. The localized force may be applied in a pattern, such as to form a conductive interconnect layer, or a contiguous conductive sheet. For instance, where a ball bearing is used, the localized force can be applied in a pattern traversed by the ball bearing.

In some implementations, the material is transferred to an acceptor substrate susceptible to deterioration upon exposure to pressure, heat and/or solvent, and with the localized-force transfer being implemented in a manner that does not require high heat, solvent or excessive force. As such, transfer can be effected under one or more conditions involving low heat (e.g., that does not substantially exceed room temperature), using little or no solvent and under low pressure conditions (e.g., 500 grams applied to a ¼ inch ball bearing). In this context, a temperature that does not substantially exceed room temperature is a temperature within about or within about 30° Celsius of room temperature, whereas a temperature that substantially exceeds room temperature may be a temperature greater than about 60° Celsius and/or a temperature that would otherwise harm components of the resulting structure.

The localized force is applied in one or more of a variety of manners. In some implementations, a localized force is applied by rolling a ball bearing upon the back surface of a substrate and translating the force through the donor substrate to the conductive material and the surface of the acceptor substrate. In some instances, the force is applied through an intervening coverslip or force-distributing layer. In certain embodiments, the localized force is applied in a pattern that traverses the back surface of the donor substrate, and a conductive interconnect layer having the pattern is formed by impressing portions of the conductive material upon the surface of the acceptor substrate. This approach can be used to form a mesh, a transparent electrode or a contiguous conductive sheet. For instance, an electrode formed in this manner has a plurality conductors in a pattern and passes a majority of incident light, such as may be applied via a ball bearing to transfer material having a width the same as or less than a diameter of the ball bearing, or less than twice the diameter of the ball bearing. Various patterns are formed, such as patterns including elongated linear portions, elongated non-linear portions, contiguous portions, disparate portions, and point-located portions having an area about commensurate with an area of the ball bearing.

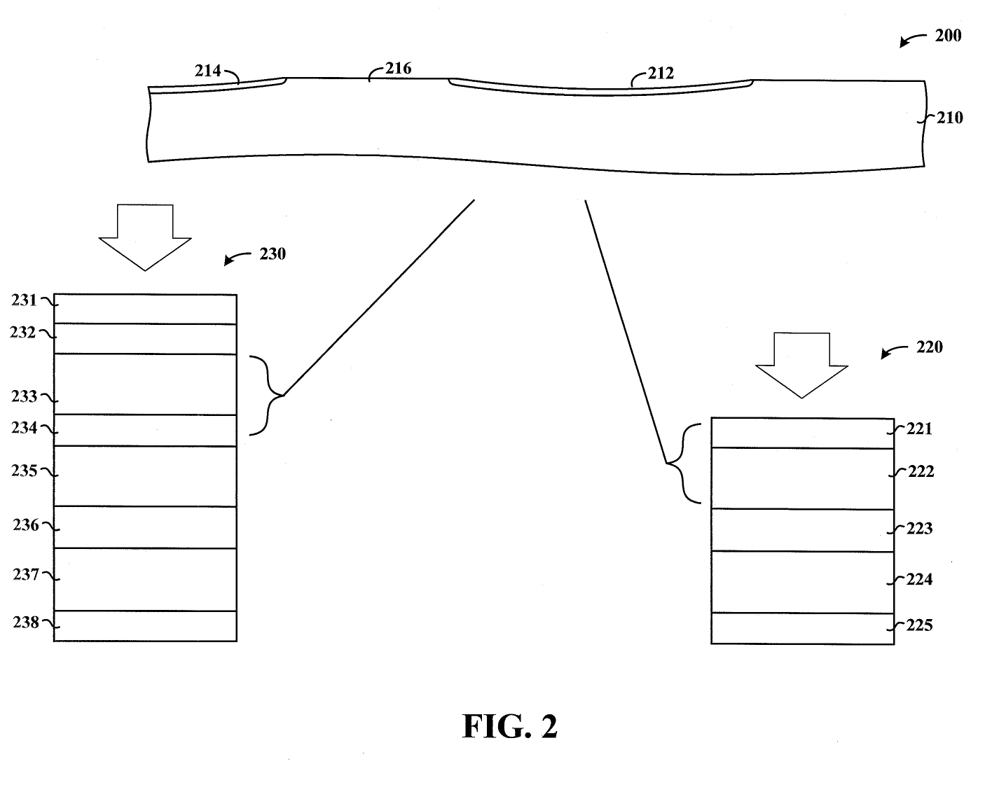

Another embodiment is directed to an apparatus having a substrate and a conductive material impressed upon a surface of the substrate in a pattern. The conductive material and portions of the substrate laterally adjacent the conductive material have a contiguous shape that conforms to a localized force applied to the substrate and to the conductive material, the shape including a portion that is indented into the surface. Such a shape may, for instance, be implemented in a manner similar to that shown in FIG. 2. In some implementations, the conductive material includes contiguous portions of the conductive material in a pattern, with the contiguous shape having a central portion that is centered upon and aligned with the contiguous portions. Accordingly, the central portion of respective particles or strips formed via an applied force may be flanked by edge portions protruding from the substrate and from a central portion of the conductive material (e.g., portions not indented in to the substrate as far as the central portion).

Various embodiments are directed to implementations involving transparent conductive films, and nanowire applications. For general information regarding transparent conductive films, and for specific information regarding such film applications with which various embodiments herein may be implemented, reference may be made to U.S. Pat. No. 8,932,898 (to Christoforo, et al.), which is fully incorporated herein by reference. For further information regarding nanowire applications, and for specific information regarding nanowire applications with which various embodiments herein may be implemented, reference may also be made to U.S. Patent Publication No. 2014/0090870 (to Garnett, et al.), which is also fully incorporated herein by reference.

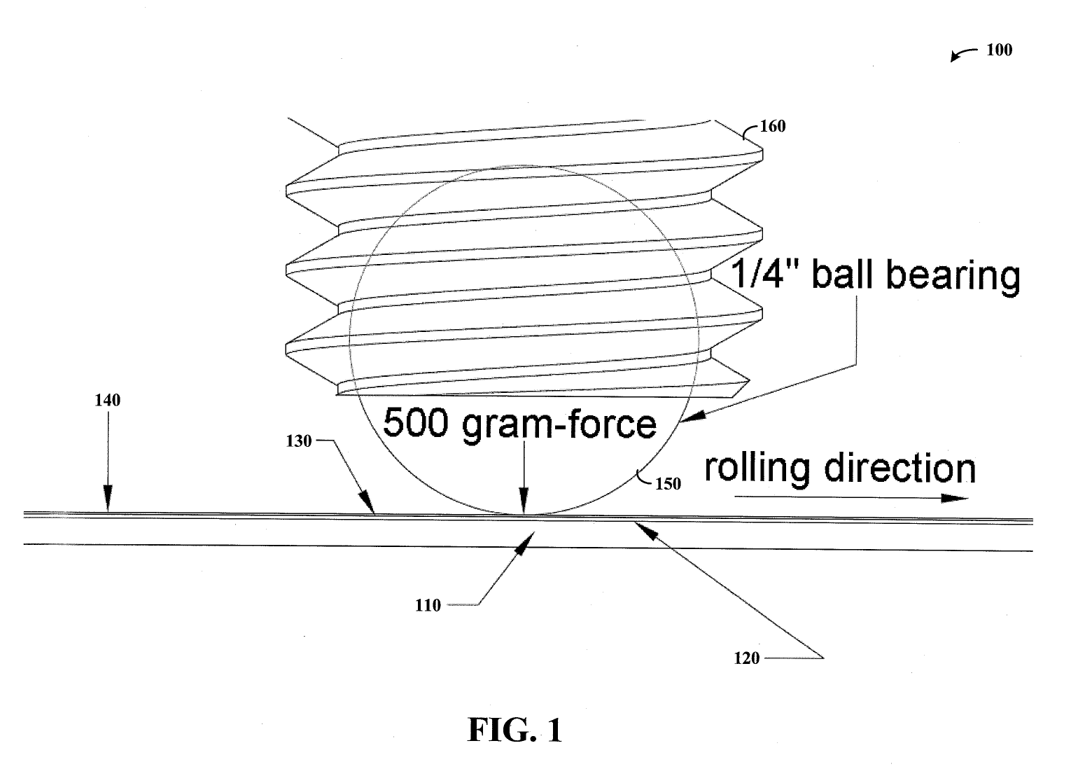

Turning now to the figures, FIG. 1 shows an apparatus 100 and approach for transferring material from a donor substrate to an acceptor substrate, in accordance with one or more embodiments. A acceptor substrate 110 such as a glass-based substrate has devices (e.g., circuits) in a layer 120 formed thereupon. A donor substrate 130 (e.g., PET) having a transfer material such as AgNWs is placed in contact with the layer 120, and a coverslip 140 is in place over the donor substrate.

A ball bearing 150 is contacted to the coverslip 140, with a downward force shown by way of example as being applied via a threaded applicator 160. The downward force transfers the material from the donor substrate 130, to an upper surface of the acceptor substrate 110. Such an approach is amenable to implementation, for example, for transferring a transparent electrode to a solar cell or touch screen type device, in a manner consistent with the above.

FIG. 2 shows an apparatus 200 and exemplary devices 220 and 230 in which the apparatus 200 may be employed, as consistent with one or more example embodiments. The apparatus 200 is shown in cross-section, with a acceptor substrate 210 having a donated conductive material 212 embedded therein. The conductive material 212 is formed in a mesh or other type of pattern of conductive portions including portion 214, separated by a gap such as gap 216. The gaps may, for example, pass light with the conductive material forming electrode that may be implemented as a transparent electrode, as may be implemented with a solar cell or touch screen. The shape of the conductive material 212 conforms to pressure applied for transferring the material, such as via a ball bearing as shown in FIG. 1. The resulting structure manifests characteristics of such transfer, and may also exhibit a corresponding indentation or recess.

Device 220 is a bottom cell device with a silver nanowire electrode 221 transferred as above to a perovskite layer 222, which is formed on a tunnel junction/recombination layer 223 and a silicon or CIGS substrate 224, having a rear contact 225. The exemplary device 220 may, for example, be implemented for solar cell implementations as described herein.

Device 230 is a hybrid tandem solar cell device with a silver nanowire electrode 234 on a perovskite layer 233. A transparent front electrode 232, such as a fluorine-doped tin oxide (FTO) electrode, and upper glass 231 form the remainder of the upper portion of the hybrid device. A lower portion of exemplary device 230 includes transparent electrode 236, a bottom substrate 237 (e.g., silicon or CIGS), and rear contact 238, separated by region 235. Accordingly, four terminals are provided at 232, 234, 236 and 238.

In some implementations, the top and bottom cells of exemplary device 230 are fabricated independently and mechanically stacked upon one another. The performance of each cell is added together to arrive at a tandem efficiency. In some implementations, current matching between the top and bottom strings of cells is achieved at the module level by adjusting the cell sizes and numbers of cells per string. This configuration facilitates two-terminal operation and a single inverter. Using a semi-transparent perovskite solar cell as the top cell, efficiency can be enhanced. For instance, for silicon substrates (at 237), efficiency increases of more than 5% can be achieved, facilitating commercialization

In some implementations, the a mesoporous titanium dioxide (TiO2) layer is infiltrated with perovskite layer (233) and contacted on either side by electron-selective (compact TiO2) and hole-selective (2,2′,7,7′-tetrakis(N,N′-di-p-methoxyphenylamine)-9,9′-spirobifluorene, spiro-OMeTAD) contacts. The transparent front electrode (231) is FTO coated glass. The silver nanowire electrode 234 operates as an electrode with low sheet resistance yet provides relatively high transmission for passing light to the underlying electrode. For instance, such an electrode can be highly transparent in the 600-1000 nm wavelength range, where perovskite is not absorbing all incident light and the underlying cell has significant external quantum efficiency (EQE). The sheet resistance of the transparent electrode can be limited to 10 Ω/□, facilitating high lateral conductivity and minimizing resistive loss when carrying the large current density. Using a transfer approach as described herein, the electrode is applied after deposition of a spiro-OMeTAD layer onto a temperature- and solvent-sensitive perovskite solar cell without damaging it.

In a particular embodiment, an apparatus as characterized above is formed as follows. A AgNW transparent electrode is formed on a flexible PET film by spray deposition, forming a AgNW film that is 12.4 Ω/□ and exhibits 90% transmission between 530 and 730 nm, falling off to 87% at 1000 nm. The AgNW film is then completely and uniformly donated from the PET to a top spiro-OMeTAD layer of a perovskite solar cell by mechanical transfer, without damaging the sensitive AgNW or perovskite films. As a result of the transfer, the conductivity of the AgNW film is improved (e.g., by 2 Ω/□). Planarization of the AgNW film due to the downward force of the transfer lamination process can reduce the resistance of junctions between wires, and AgNWs are embedded into the moderately conductive spiro-OMeTAD layer (˜10−3 S/cm). Using this approach, the fabrication of the perovskite solar cell is decoupled from fabrication of the electrode, allowing each to be optimized independently. Independent fabrication can eliminate thermal or solvent damage that the spiro-OMeTAD or perovskite may otherwise incur during the AgNW deposition process. The semi-transparent solar cell is completed by depositing two LiF anti-reflective (AR) coatings, 133 nm onto the glass surface and 176 nm on top of the AgNW electrode to improve transmission through the device. The semi-transparent solar cell is as efficient as its opaque Au electrode counterpart with desirable short-circuit current (JSC), open-circuit voltage (VOC) and fill factor (FF).

Various other figures are shown in Appendices A-B that form part of this document. One or more figures therein are implemented in connection with one or more embodiments, or claims herein. For instance, performance-based graphs shown in Appendix A and the discussion and examples of thin-film transfer lamination of Appendix B can be implemented in connection with certain method and apparatus-based embodiments described above.

Based upon the above discussion and illustrations, those skilled in the art will readily recognize that various modifications and changes may be made to the various embodiments without strictly following the exemplary embodiments and applications illustrated and described herein. For example, a variety of different circuit structures and manners in which to make such structures may be combined, and a variety of types of transfer structures (e.g., different substrates, and different pressure-applicators) may be used for different implementations or combined. In addition, the various embodiments described herein (including those in Appendices A-B) may be combined in certain embodiments, and various aspects of individual embodiments may be implemented as separate embodiments. Such modifications do not depart from the true spirit and scope of various aspects of the invention, including aspects set forth in the claims.

What is claimed is:

1. A method comprising:
placing a front surface of a donor substrate upon a surface of an acceptor substrate, the front surface having donor material formed thereupon; and
transferring a portion of the donor material from the donor substrate to a target surface region of the acceptor substrate by applying a localized-force to a back surface of the donor substrate that is opposite the donor material in the region being transferred, in such a way that if the donor and acceptor substrates were physically separated a portion of the donor material would remain on the acceptor substrate in the region(s) the force was applied.

2. The method of claim 1, wherein transferring a portion of the donor material includes forming an electrode on the acceptor substrate, the electrode having a plurality of conductive particles of the donor material that when taken together form an electrically conductive surface and pass a majority of incident light.

3. The method of claim 2, wherein applying the localized-force to the back surface of the donor substrate includes applying the localized-force in a pattern that traverses the back surface of the donor substrate, and forming a conductive interconnect layer on the acceptor substrate surface and having the pattern by impressing portions of the conductive material upon the surface of the acceptor substrate.

4. The method of claim 2, wherein applying the localized-force to the back surface of the donor substrate includes applying the localized-force in a pattern that traverses the back side of the donor substrate, and forming a contiguous conductive sheet on the acceptor substrate surface by impressing portions of the donor material upon the surface of the acceptor substrate

5. The method of claim 1, wherein applying the localized force includes applying the localized force via a ball bearing.

6. The method of claim 5, wherein applying the localized force via a ball bearing includes rolling the ball bearing upon the back surface while applying a force via the ball bearing and translating the force through the donor substrate to the donor material and the surface of the acceptor substrate in such a way that donor material in a region larger than the projected area of the ball bearing is donated to the acceptor substrate.

7. The method of claim 6, wherein
the acceptor substrate is susceptible to deterioration upon exposure to at least one of heat and solvent, and
applying the localized-force includes impressing the portion of the donor material into the surface of the acceptor substrate with the ball bearing at room temperature and with substantially no solvent being exposed to the acceptor substrate.

8. The method of claim 1, wherein
the acceptor substrate is susceptible to deterioration upon exposure to at least one of heat and solvent, and
transferring the portion of the donor material from the donor substrate to the target surface region of the acceptor substrate includes impressing the portion of the donor material upon the surface of the acceptor substrate at room temperature and with substantially no solvent being exposed to the acceptor substrate.

9. A method comprising:
placing a front surface of a donor substrate upon a surface of an acceptor substrate, the front surface having conductive material formed thereupon; and
transferring a portion of the conductive material from the donor substrate to a target surface region of the acceptor substrate by applying a localized force to a back surface of the donor substrate that is opposite the front surface, while mitigating application of the applied localized force to other surface regions of the acceptor substrate that are adjacent the target surface region.

10. The method of claim 9, wherein applying the localized force includes concentrating a majority of the localized force to the target surface region.

11. The method of claim 9, wherein transferring a portion of the conductive material includes forming an electrode that has a plurality conductors in a pattern and that passes a majority of incident light, by rolling a ball bearing on the back surface of the donor substrate and using the ball bearing to apply the localized force along the pattern.

12. The method of claim 11, wherein rolling the ball bearing includes concentrating a majority of force applied by the ball bearing to portions of the target surface region having a size that is less than a diameter of the ball bearing.

13. The method of claim 11, wherein rolling the ball bearing includes concentrating a majority of force applied by the ball bearing to portions of the target surface region having a size that is less than about twice a diameter of the ball bearing.

14. The method of claim 11, wherein the pattern includes at least one of: elongated linear portions, elongated non-linear portions, contiguous portions, disparate portions, and point-located portions having an area about commensurate with an area of the ball bearing.

15. The method of claim 9, wherein applying the localized force to the back surface of the donor substrate includes:
rolling a ball bearing upon the back surface while applying a force via the ball bearing, and
translating the force through the donor substrate to the conductive material and the surface of the acceptor substrate.

16. The method of claim 15, wherein
the acceptor substrate is susceptible to deterioration upon exposure to at least one of heat and solvent, and
applying the localized force includes impressing the portion of the conductive material into the surface of the acceptor substrate with the ball bearing at a temperature that does not substantially exceed room temperature and with substantially no solvent being exposed to the acceptor substrate.

17. The method of claim 9, wherein
the acceptor substrate is susceptible to deterioration upon exposure to at least one of heat and solvent, and
transferring the portion of the conductive material from the donor substrate to the target surface region of the acceptor substrate includes impressing the portion of the conductive material upon the surface of the acceptor substrate at a temperature that does not substantially exceed room temperature and with substantially no solvent being exposed to the acceptor substrate.

18. The method of claim 9, wherein applying the localized force to the back surface of the donor substrate includes applying the localized force in a pattern that traverses the back surface of the donor substrate, and forming a conductive interconnect layer having the pattern by impressing portions of the conductive material upon the surface of the acceptor substrate.

19. The method of claim 9, wherein applying the localized force to the back surface of the donor substrate includes applying the localized force in a pattern that traverses the back side of the donor substrate, and forming a contiguous conductive sheet by impressing portions of the conductive material upon the surface of the acceptor substrate.

20. The method of claim 9, further comprising depositing the conductive material on the front surface of the donor substrate, prior to placing the front surface of the donor substrate upon the surface of the acceptor substrate.

21. The method of claim 20, wherein depositing the conductive material on the front surface of the donor substrate includes configuring the conductive material with the donor substrate to release the conductive material in response to the localized force, and to transfer about all of the conductive material to the acceptor substrate via the localized force.

22. An apparatus comprising:
a substrate having a surface; and
a conductive material impressed upon the surface in a pattern, the conductive material and portions of the substrate laterally adjacent the conductive material having a contiguous shape that conforms to a localized force applied to the substrate and to the conductive material, the shape including a portion that is indented into the surface.

23. The apparatus of claim 22, wherein the conductive material includes a plurality of contiguous portions of the conductive material in a pattern, with the contiguous shape having a central portion that is centered upon and aligned with the contiguous portions.

24. The apparatus of claim 22, wherein the conductive material includes a plurality of contiguous portions of the conductive material in a pattern, with the contiguous shape having a central portion that is centered upon and aligned with each contiguous portion of conductive material, and with an edge portion of the conductive material protruding from the substrate and from a central portion of the conductive material.
